(19) United States
(12) Patent Application Publication
(10) Pub. No.: US 2014/0220258 A1
(43) Pub. Date: Aug. 7, 2014

(54) METHOD OF FABRICATING GRAPHENE USING A PLURALITY OF LIGHT SOURCES

(71) Applicants: Seoul National University R&DB Foundation, Seoul (KR); TOSHIBA SAMSUNG STORAGE TECHNOLOGY KOREA CORPORATION, Suwon-si (KR)

(72) Inventors: Byung-Youn SONG, Suwon-si (KR); Kil-Soo Choi, Seoul (KR); Nag-Eui Choi, Suwon-si (KR); Hyoung-Sub Shim, Seoul (KR); Han-Yung Jung, Seoul (KR); Jung-Hoon Lee, Seoul (KR)

(73) Assignees: Seoul National University R&DB Foundation, Seoul (KR); TOSHIBA SAMSUNG STORAGE TECHNOLOGY KOREA CORPORATION, Suwon-si (KR)

(21) Appl. No.: 14/044,406

(22) Filed: Oct. 2, 2013

(30) Foreign Application Priority Data
Feb. 5, 2013 (KR) 10-2013-0013046

(51) Int. Cl. B05D 3/06; C01B 31/04

(52) U.S. Cl. CPC B05D 3/065; C01B 31/0476
USPC 427/554; 250/492.1; 204/157.41

(57) ABSTRACT

A method of fabricating graphene using a plurality of light sources is provided. The method includes irradiating a graphite oxide layer on a substrate with light from a first light source, and irradiating the irradiated graphite oxide layer with light from a second light source.

### CROSS-REFERENCE TO RELATED APPLICATION(S)

This application claims the benefit under 35 U.S.C. §119(a) of Korean Patent Application No. 10-2013-0013046, filed on Feb. 5, 2013, in the Korean Intellectual Property Office, the entire disclosure of which is incorporated herein by reference for all purposes.

### BACKGROUND

1. Field

The following description relates to a graphene fabrication method, and to, for example, a graphene fabrication method using a plurality of light sources.

2. Description of Related Art

Graphene is an allotrope of carbon, consisting of a single two-dimensional planar sheet of carbon atoms with a thickness of about 0.35 nanometers. In a graphene sheet, carbon atoms are packed into a honeycomb lattice, forming free spaces therebetween. The arrangement of carbon atoms and free spaces therebetween provide a graphene molecule with flexibility that allows a certain degree of deformation, such as bending and twisting. In addition, a hexagonal arrangement of carbon atoms ensures electrical conductivity and chemical stability.

Graphene can carry two hundred times more current than copper and can carry current two hundred times faster than silicon at a room temperature. In addition, graphene has twice the room-temperature thermal conductivity than diamond, and two hundred times more mechanical strength than steel. Therefore, researches for the utilization of graphene, as one of the most promising future electronic materials, are increasing. Due to such excellent properties, for example, an electrode made of graphene may have both high energy density of a battery and high power performance of a capacitor.

Graphene is generally obtained by an exfoliation method or a synthesis method. In an exfoliation method, a graphene layer may be exfoliated from graphite. Graphite is abundantly present in nature. Further, in comparison to a synthesis method, the exfoliation method is characterized by low energy consumption, and enables mass production of graphene. However, with the exfoliation method, it is difficult to achieve a graphene sheet having a large surface area, and the yield is generally low in comparison to the amount of graphite that is processed. The exfoliation method may be further classified into a physical exfoliation method and a chemical exfoliation method, depending on the treatment method used for exfoliation.

A synthesis method involves synthesizing a layer of graphene directly from a carbon source. In comparison to the exfoliation method, the synthesis method generally requires more energy. However, the synthesis method enables production of graphene sheets having a large surface area with low defects.

However, with the above described methods, limitations exist in effectively forming graphene sheets having a large surface area and excellent uniformity in the molecular arrangement of carbon atoms. For instance, the actual capacitance per unit weight exhibited by the graphene sheets formed by a general method is 99 to 130 F/g, which is much lower than the highest theoretical capacitance value, 550 F/g.

A method of fabricating graphene using a single type of light source, such as laser, has been suggested. However, laser light is concentrated on a relatively small area, and thus it may take a substantial amount of time and energy irradiating a large area with the laser light to obtain graphene by the suggested method, and the quality of graphene may vary depending on a position of laser irradiation to a graphite oxide layer.

### SUMMARY

In one general aspect, there is provided a method of fabricating graphene, including: irradiating a graphite oxide layer on a substrate with light from a first light source; and irradiating the irradiated graphite oxide layer with light from a second light source. The first light source may be a laser light source, and the second light source may be a flash light source.

In the alternative, the first light source may be a flash light source, and the second light source may be a laser light source.

The laser light source may emit light of wavelengths used in an optical recording device and/or an optical reproducing device.

The laser light source may emit light of wavelengths in a range of 400 nm to 820 nm.

The flash light source may include xenon flash and UV flash.

The general aspect of the method may further include: irradiating the second-light-irradiated graphite oxide layer with light from a third light source.

The third light source may be either a laser light source or a flash light source.

The first and second light sources may be laser light sources while the third light source may be a flash light source, or the first and second light sources may be flash light sources while the third light source may be a laser light source.

The first light source may be a laser light source while the second and third light sources may be flash light sources, or the first light source may be a flash light source while the second and third light sources may be laser light sources.

The substrate may be a thermoplastic polymer substrate containing polycarbonate.

In another general aspect, there is provided a method of fabricating graphene, including: forming a graphite oxide layer on a substrate; and irradiating the graphite oxide layer with both laser light and flash light to reduce the graphite oxide layer in a stepwise manner.

The reducing of the graphite oxide layer may include irradiating the graphite oxide layer alternately with the laser light and the flash light.

The reducing of the graphite oxide layer may include irradiating the graphite oxide layer with one of the laser light and the flash light twice consecutively, and then irradiating the graphite oxide layer again with the other light once.

The reducing of the graphite oxide layer may include irradiating the graphite oxide layer with one of the laser light and the flash light once, and then irradiating the graphite oxide layer again with the other light twice consecutively.

The substrate may be a thermoplastic polymer substrate containing polycarbonate.

The laser light may have a wavelength in a range of 400 nm to 820 nm.

The irradiating of the graphite oxide layer with laser light may involve exposing the graphite oxide layer formed on an optical disk to laser light from a laser light source of an optical recording device or an optical reproducing device.

The general aspect of the method may further involve collecting graphene from the reduced graphite oxide layer.

Other features and aspects may be apparent from the following detailed description, the drawings, and the claims.

### BRIEF DESCRIPTION OF THE DRAWINGS

FIG. 1 is a flowchart illustrating an example of a method of fabricating graphene.

FIGS. 2 to 10 are flowcharts illustrating other examples of methods of fabricating graphene.

FIG. 11 is a graph illustrating power density and energy density of graphene produced by an example of a fabrication method according to the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

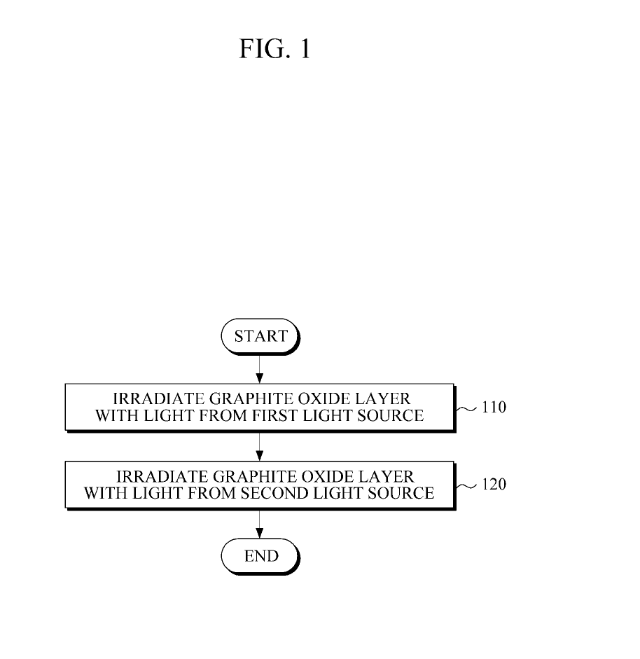

FIG. 1 is a flowchart illustrating an example of a method of fabricating graphene.

The method includes irradiating a thin film layer of graphite oxide applied on a polycarbonate substrate of an optical disk, such as a DVD, CD, and the like, with light from both a laser light source and a flash light source, at least one time, in order to, to gradually reduce graphite oxide in the graphite oxide layer to graphene.

Polycarbonate, as a member of a particular thermoplastic polymer group, is capable of being easily manipulated, injection-molded and thermoformed. Polycarbonate is multifunctional engineering plastic with excellent heat-resistance, impact resistance, and optical properties, thereby being widely used for product plastic and engineering plastic and also as a material for exteriors of information appliances, such as, mobile phones, notebook computers, and monitors, and optical storage media, such as CDs and DVDs.

Although polycarbonate is taken as an example of a substrate material, the substrate may be made of various types of materials, such as resins, ferrous metals and non-ferrous metals.

Referring to FIG. 1, in 110, light from a first light source is used to irradiate a thin film of a graphite oxide layer applied on a surface of the substrate. Then, light from a second light source is used to further irradiate the irradiated graphite oxide layer in order to reduce the graphite oxide in 120.

In this example, the first light source may be a laser light source, and the second light source may be a flash light source, or vice versa. For example, the laser light source may emit light of wavelengths used in an optical recording device and/or an optical reproducing device. For example, a general laser light source radiates infrared laser light having a wavelength of approximately 780 nm. The wavelength of laser light used in this example may be between 400 nm and 820 nm, but the range of wavelength of the laser light source is not limited thereto.

Flash light radiated from a flash light source momentarily releases energy greater than a predetermined amount. A flash light source that is generally used in a camera is a light source that emits strong light energy over a large area for a short period of time. In this example, various types of flash light sources, such as xenon flash, UV flash, and the like, may be used.

For example, to generate xenon flash light, xenon is injected into a hermetically sealed tube made of quartz glass, which is maintained within a pressure of 1 to 10 percent of atmospheric pressure. Then, a high voltage is applied between both electrodes of the tube, whereby a discharge occurs and a gas is ionized. After a certain period of time, currents of thousands of amperes from a charged condenser pass through the tube while exciting xenon atoms, resulting in the generation of flash light. Xenon flash light is white light having electromagnetic waves of all wavelengths. In an application that requires the use of electromagnetic waves having wavelengths in the infrared range, a different gas, such as krypton, may be used.

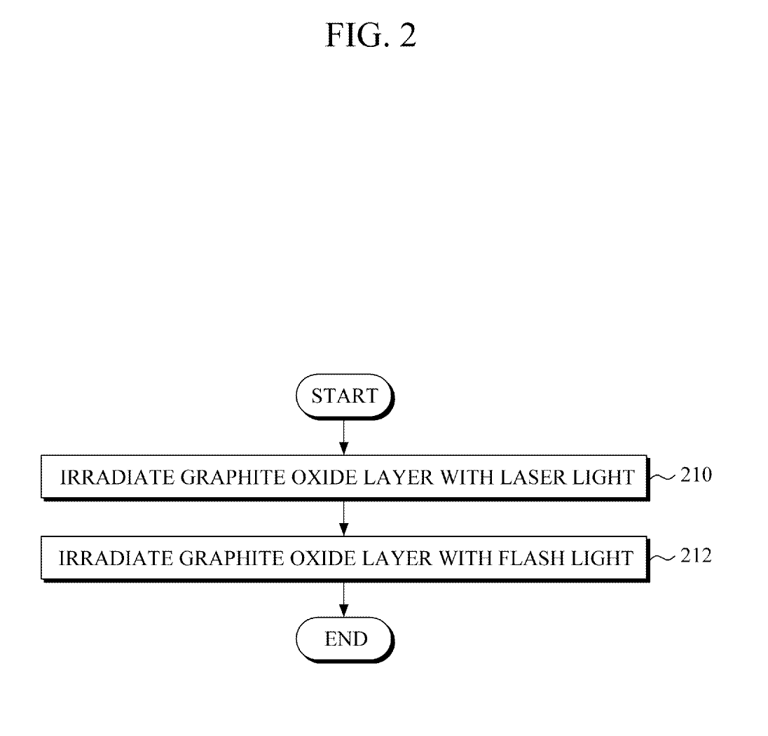

FIGS. 2 to 10 are flowcharts illustrating examples of modifications to the method of fabricating graphene illustrated in FIG. 1.

According to the example illustrated in FIG. 2, a thin film of graphite oxide layer applied on a substrate is irradiated by light from a laser light source, thereby being primarily reduced in 210. Then, in 212, the primarily reduced graphite oxide layer is irradiated by flash light from a flash light source, thereby being secondarily reduced. The secondarily reduced graphite oxide layer includes graphene, which is the reduction product of graphite oxide. It is understood that the graphite oxide layer being irradiated may include an intermediate reduction product of graphite oxide while the irradiation operations are being performed.

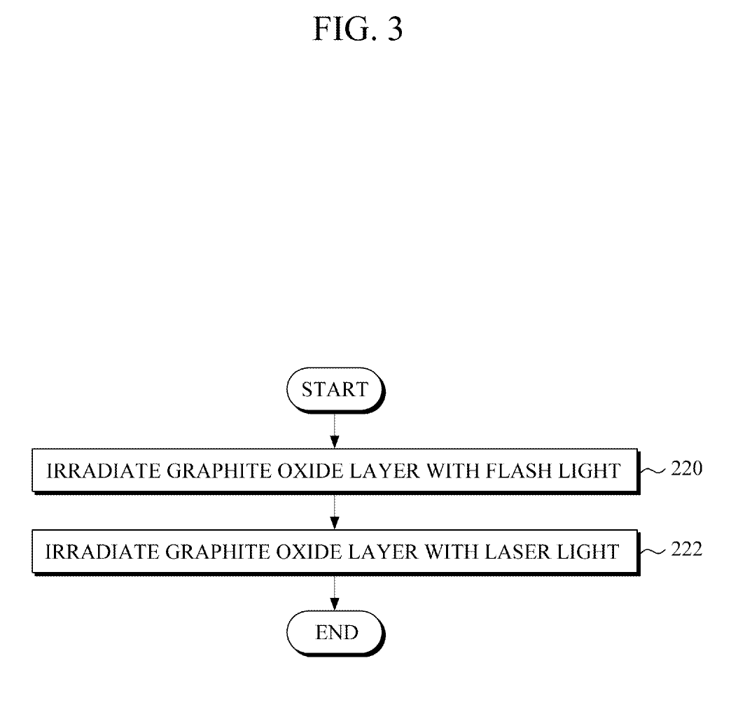

In another example of a method of fabricating graphene from a graphite oxide layer, the order of performing operations of FIG. 2 may be switched as shown in FIG. 3. In the example illustrated in FIG. 3, a thin film of graphite oxide applied on a substrate is irradiated by exposure to flash light from a flash light source in 220, thereby being primarily reduced. Then, in 222, a fully reduced graphite oxide layer is obtained by irradiating the primarily reduced graphite oxide layer with laser light from a laser light source.

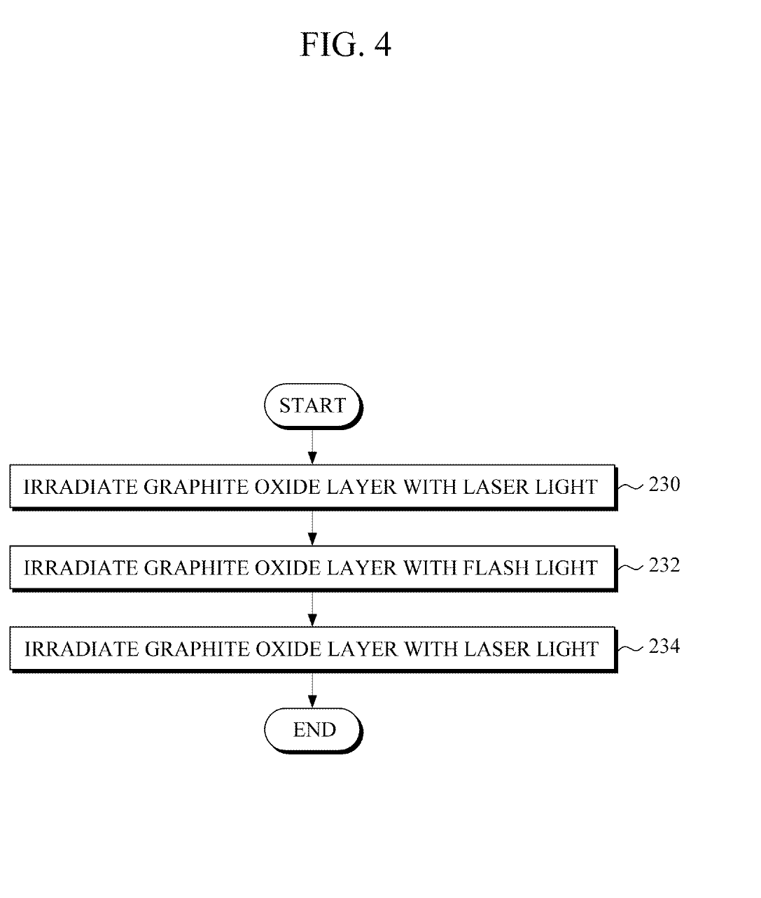

In additional examples illustrated in FIGS. 4 to 9, the secondarily reduced graphite oxide layer may be further irradiated with light, thereby enhancing the purity of the obtained graphene and increasing the surface area of graphite oxide that is reduced to obtain graphene. As illustrated, many modifications can be made to the method of irradiating laser light and flash light in an alternating manner.

Referring to FIG. 4, a thin film of graphite oxide applied on a substrate is primarily reduced by irradiating it with light from a laser source in 230. The primarily reduced graphite oxide layer is secondarily reduced by irradiating it with light from a flash light source in 232. Thereafter, final graphene is obtained by irradiating light from the laser light source to the secondarily reduced graphite oxide layer in 234.

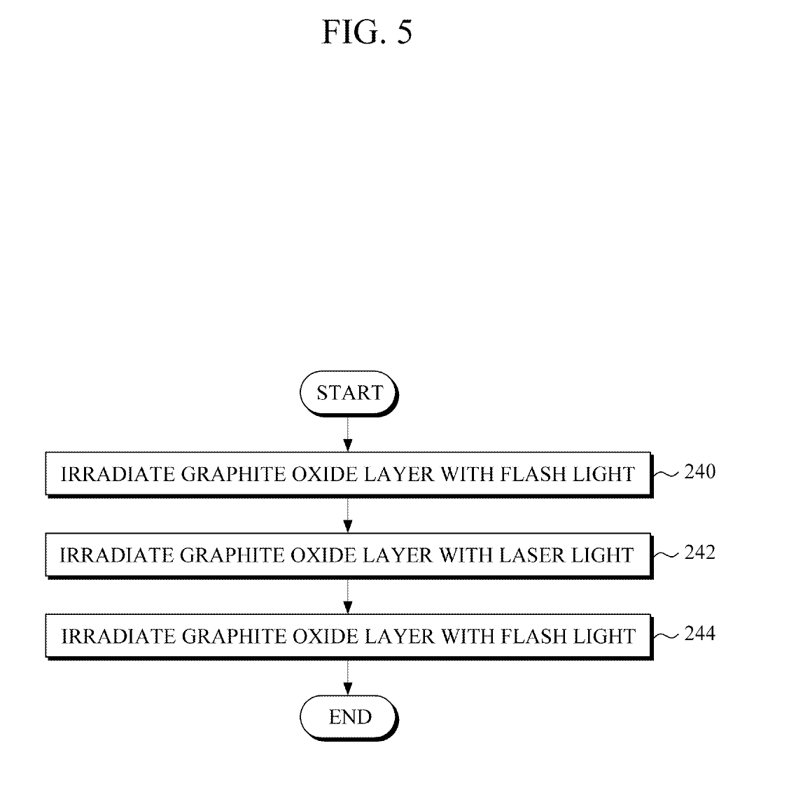

The order of performing operations illustrated in FIG. 4 may be switched. For example, as shown in FIG. 5, the thin film of graphite oxide applied on the substrate may be primarily reduced by irradiating it with light from the flash light source in 240. Then, the primarily reduced graphite oxide layer may be secondarily reduced by irradiating it with light from the laser light source in 242. Thereafter, graphene is finally obtained by irradiating the secondarily reduced graphite oxide layer with light from the flash light source in 244.

Also, unlike the examples shown in FIGS. 4 and 5, the same type of light, either flash light or laser light, may be used to irradiate the graphite oxide layer consecutively for two or more times.

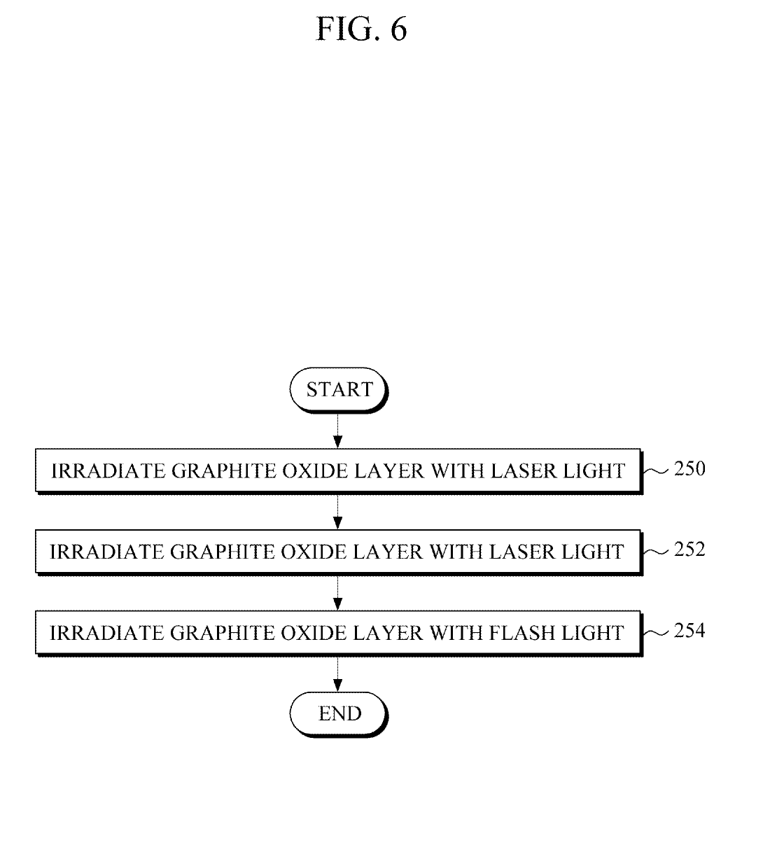

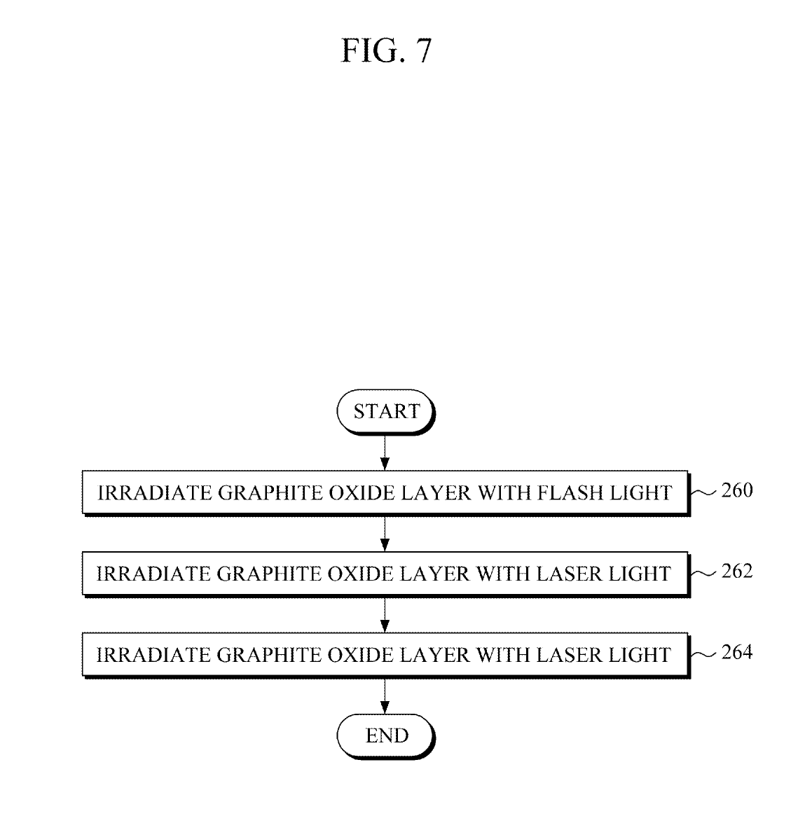

For example, as shown in FIG. 6, after a graphite oxide layer is irradiated with laser light in 250, the graphite oxide layer may be further irradiated by the laser light in 252, and then by flash light in 254. In addition, as shown in FIG. 7, the order of the irradiation operations may be changed, wherein the flash light is first irradiated on the graphite oxide layer in 260 and then laser light is used to irradiate the reduced graphite oxide layer successively in 262 and 264.

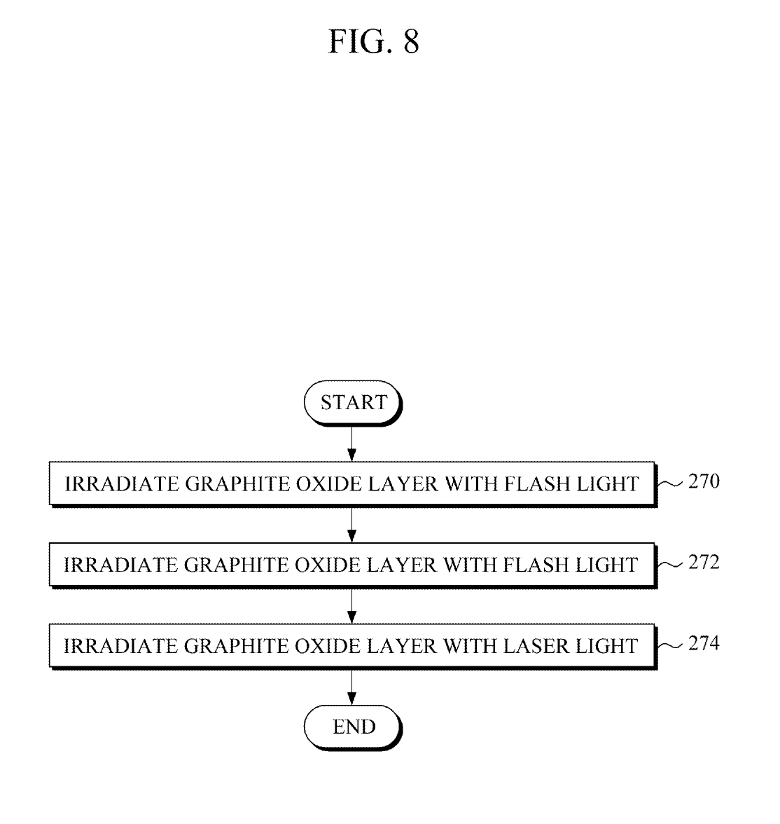

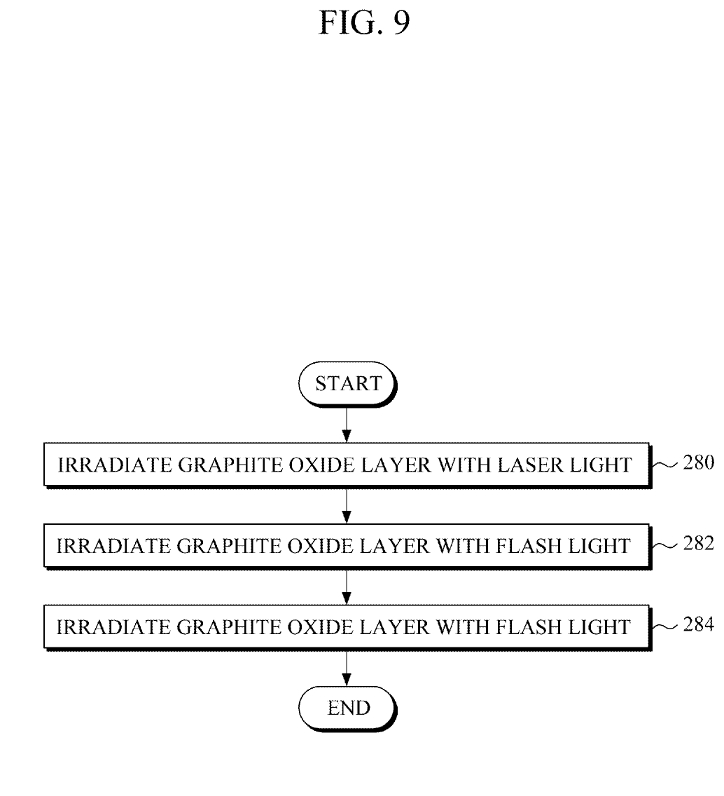

In the example illustrated in FIG. 8, a graphite oxide layer is successively irradiated twice by flash light in 270 and 272. Thereafter, the graphite oxide layer is irradiated with laser light in 274. Alternatively, as shown in FIG. 9, a graphite oxide layer may be first irradiated with laser light in 280, and then irradiated successively with flash light for two times in 282 and 284.

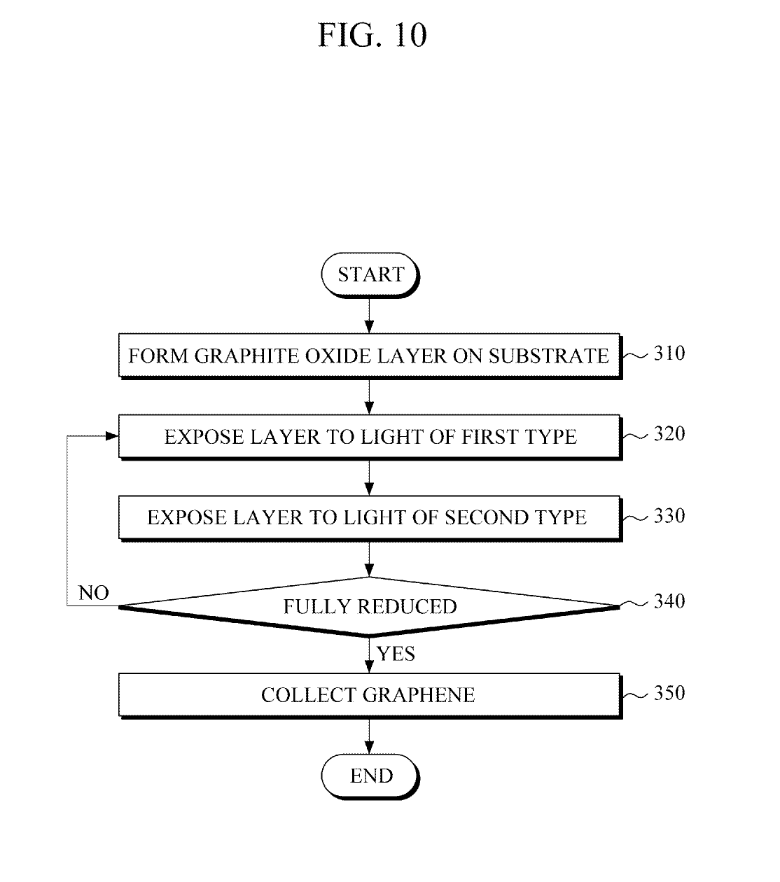

In the example illustrated in FIG. 10, a graphite oxide layer is formed on a substrate in 310. The substrate may be a polycarbonate substrate of an optical disk. In the alternative, the substrate may be a plate having a dimension similar to an optical disk. For example, the plate may be a thermoplastic polymer substrate having a diameter or width greater than 6 cm and less than 30 cm, or greater than 11 cm and less than 13 cm. The graphite oxide layer may include graphite oxide powder.

The graphite oxide layer may be exposed to light of first type and light of second type in an alternating manner in 320 and 330. However, exposure to light of one type may be repeated for twice or more before the layer is exposed to light of the other type. In this example, the light of first type and the light of second type may be laser light and flash light.

Also, three or more light sources that produce different wavelengths may be used to irradiate the graphite oxide layer. The exposure to alternating types of light may be repeated until the graphite oxide in the layer is fully reduced to graphene. In 350, the fully reduced graphene is collected or gathered from the surface of the substrate. When graphene is collected, it is possible that some portions of the graphite oxide layer may still include graphite oxide that has not been fully reduced.

In the examples shown in FIGS. 2 to 10, the flash light or the laser light is irradiated two or three times. However, the number of irradiation is not limited thereto, and the light irradiation by the same light source may be repeated more than three times in a given method.

Laser light is radiation that results from simultaneous emission of a large quantity of photons, and generally irradiates only a small area that is however strongly affected by the direct laser irradiation. For example, an area irradiated by infrared laser light is about 1 μm in diameter. Accordingly, it is difficult and inefficient to irradiate the entire area of a graphite oxide layer formed on a substrate with the laser light. To overcome such difficulties, flash light irradiation is also carried out to provide optical energy simultaneously to a large area. By the flash light irradiation, a remaining area of the graphite oxide layer, other than the area that is directly irradiated with laser light and is hence most strongly reduced, is reduced with flash light, so that a specific surface area is increased, resulting in a high capacitance. The laser light irradiation and the flash light irradiation may be performed in a complementary manner.

An explosion may occur on the surface of the graphite oxide layer when the simultaneous reduction of a large area by the flash light takes place. Such an explosion results in the graphite oxide layer having a porous structure. As the layer has more pores, the specific surface layer increases, and thus the layer can accumulate more electric charges, resulting in a higher capacitance, when compared with the case of fabricating a capacitor.

In one example, the reduced graphene may be collected in a form of a compressed layer of graphene. The graphite oxide layer that is exposed to laser light tends to be reduced as graphene in a form of a compressed layer. Exposure to flash light tends to result in a powder form of graphene. Performing a laser light irradiation before a flash light reduction may secure the structure of the graphite oxide layer, so that the laser light-irradiated graphite oxide layer is prevented from being scattered during a flash light irradiation process. Accordingly, in one example, the graphite oxide layer is first exposed to laser light before being exposed to flash light. However, the method of reducing the graphite oxide layer applied on the substrate is not limited thereto.

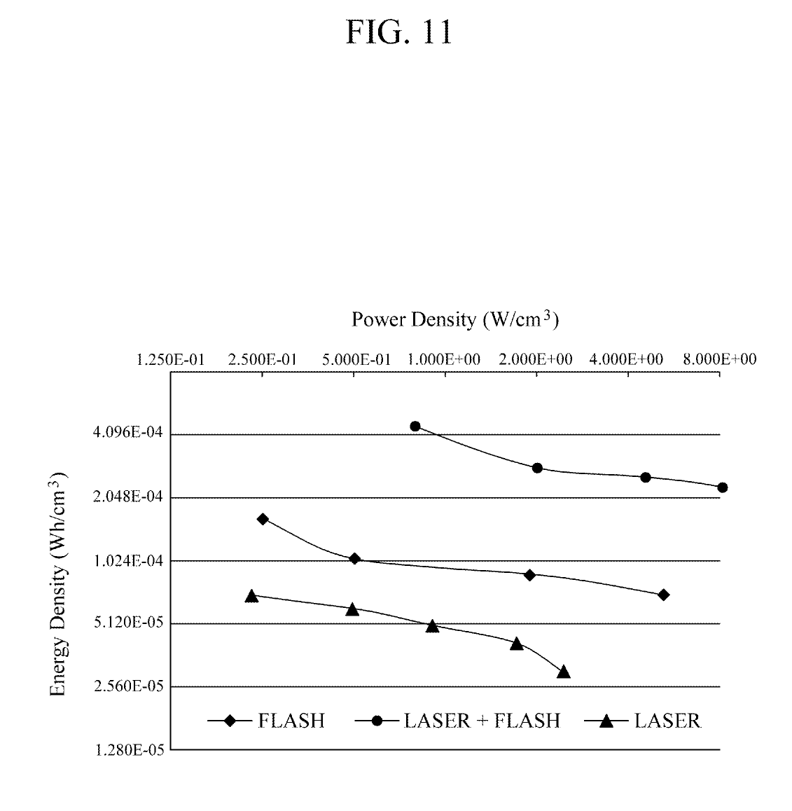

FIG. 11 is a graph illustrating power density and energy density of graphene produced by an example of a method described above.

Referring to FIG. 11, it is noticed that, in comparison with an energy storage element, such as a capacitor, which is made of graphene produced via either laser light or flash light, an energy storage element made of graphene fabricated via both laser light and flash light has higher power density and energy density. In the example illustrated in FIG. 11, 1.0 M of sulfuric acid aqueous solution is used as an electrolyte.

Both a laser light source and a flash light source are used in fabrication of graphene by reducing a graphite oxide layer, so that drawbacks that may be caused when only one type of light source is used can be overcome and mass-production of high-quality graphene at a lower cost can be realized. In addition, the graphene produced by the examples of methods described above has superior characteristics than graphene produced by other methods.

Described above are examples of methods of fabricating graphene by gradually reducing a graphite oxide layer to graphene while irradiating the graphite oxide layer with each of laser light and flash light at least once. Also described above are examples of methods of fabricating graphene, including: irradiating a thin film of graphite oxide layer applied on a substrate with light from a first light source; and irradiating the irradiated graphite oxide layer with light from a second light source. The first light source may be a laser light source while the second light source may be a flash light source, or the first light source may be a flash light source while the second light source may be a laser light source. In addition, the examples of methods may further include irradiating the second-light-irradiated graphite oxide layer with light from a third light source, and the third light source may be either a laser light source or a flash light source.

Also described above are examples of methods of fabricating graphene, including: preparing a substrate with a thin film of graphite oxide layer applied thereon; and irradiating the graphite oxide layer with each of laser light and flash light at least once to reduce the graphite oxide layer in a stepwise manner. The reducing of the graphite oxide layer may include irradiating the graphite oxide layer alternately with the laser light and the flash light one at a time. The reducing of the graphite oxide layer may include irradiating the graphite oxide layer with one of the laser light and the flash light twice consecutively, and then irradiating the graphite oxide layer again with the other light once. Alternatively, the reducing of the graphite oxide layer may include irradiating the graphite oxide layer with one of the laser light and the flash light once, and then irradiating the graphite oxide layer again with the other light twice consecutively.

By using both laser light and flash light to reduce a graphite oxide layer to graphene, it may be possible to reduce a large area of the graphite oxide layer as compared to a method in which only one light source is used. Accordingly, with these examples of methods of fabricating graphene, it is possible to realize mass production of high-quality graphene at a lower cost.

A number of examples have been described above. Nevertheless, it should be understood that various modifications may be made. For example, suitable results may be is achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of fabricating graphene, comprising:
irradiating a graphite oxide layer on a substrate with light from a first light source; and
irradiating the irradiated graphite oxide layer with light from a second light source.

2. The method of claim 1, wherein the first light source is a laser light source, and the second light source is a flash light source.

3. The method of claim 1, wherein the first light source is a flash light source, and the second light source is a laser light source.

4. The method of claim 2, wherein the laser light source emits light of wavelengths used in an optical recording device or an optical reproducing device.

5. The method of claim 2, wherein the laser light source emits light of wavelengths in a range of 400 nm to 820 nm.

6. The method of claim 2, wherein the flash light source includes xenon flash and UV flash.

7. The method of claim 1, further comprising:
irradiating the second-light-irradiated graphite oxide layer with light from a third light source.

8. The method of claim 6, wherein the third light source is either a laser light source or a flash light source.

9. The method of claim 6, wherein the first and second light sources are laser light sources while the third light source is a flash light source, or the first and second light sources are flash light sources while the third light source is a laser light source.

10. The method of claim 6, wherein the first light source is a laser light source while the second and third light sources are flash light sources, or the first light source is a flash light source while the second and third light sources are laser light sources.

11. The method of claim 1, wherein the substrate is a thermoplastic polymer substrate containing polycarbonate.

12. A method of fabricating graphene, comprising:
forming a graphite oxide layer on a substrate; and
irradiating the graphite oxide layer with both laser light and flash light to reduce the graphite oxide layer in a stepwise manner.

13. The method of claim 12, wherein the reducing of the graphite oxide layer comprises irradiating the graphite oxide layer alternately with the laser light and the flash light.

14. The method of claim 12, wherein the reducing of the graphite oxide layer comprises irradiating the graphite oxide layer with one of the laser light and the flash light twice consecutively, and then irradiating the graphite oxide layer again with the other light once.

15. The method of claim 12, wherein the reducing of the graphite oxide layer comprises irradiating the graphite oxide layer with one of the laser light and the flash light once, and then irradiating the graphite oxide layer again with the other light twice consecutively.

16. The method of claim 12, wherein the substrate is a thermoplastic polymer substrate containing polycarbonate.

17. The method of claim 12, wherein the laser light has a wavelength in a range of 400 nm to 820 nm.

18. The method of claim 12, wherein the irradiating of the graphite oxide layer with laser light involves exposing the graphite oxide layer formed on an optical disk to laser light from a laser light source of an optical recording device or an optical reproducing device.

19. The method of claim 12, further comprising:
collecting graphene from the reduced graphite oxide layer.
